(19) United States
(12) Patent Application Publication
(10) Pub. No.: US 2025/0183625 A1
(43) Pub. Date: Jun. 5, 2025

(54) QUICK DISCONNECT ARRESTER

(71) Applicant: Hubbell Incorporated, Shelton, CT (US)

(72) Inventors: Sidharth Suresh Iyer, Wadsworth, OH (US); Bastiaan Hubertus Van Besouw, Haymarket, VA (US); Stephen Franklin Poterala, AIken, SC (US)

(21) Appl. No.: 18/842,200

(22) PCT Filed: Mar. 1, 2023
(86) PCT No.: PCT/US2023/014210

§ 371 Date: Aug. 28, 2024

Related U.S. Application Data
(60) Provisional application No. 63/315,304, filed on Mar. 1, 2022.

(51) Int. Cl. H01T 1/14; H01H 39/00; H01R 4/48

(52) U.S. Cl. CPC H01T 1/14; H01H 39/004; H01R 4/48

(57) ABSTRACT

An arrester assembly including a first support member and a constant tension spring including a first end and a second end. The first end is mechanically coupled to the first support member such that the second end of the constant tension spring extends in a downward direction. The arrester assembly further includes a disconnector assembly that is electrically connected to the second end of the constant tension spring, a ground connector that is electrically connected to aground, and an arrester that is electrically connected between the disconnector assembly and the ground connector.

### RELATED APPLICATIONS

The present application claims priority to U.S. Provisional Patent Application No. 63/315,304, filed on Mar. 1, 2022, the entire contents of which is incorporated by reference herein.

### FIELD

The present application relates to overvoltage protection assemblies, such as surge arrester assemblies.

### SUMMARY

Electrical grids commonly incorporate protective devices, such as surge arresters and disconnectors, to protect associated equipment from power surges such as those due to lightning strikes, electrical switching events, etc. When a failed surge arrester and/or a failed disconnector requires replacement, one or more linemen commonly need to shut-down the line, climb up to where the arrester is installed, assess whether any nearby equipment was damaged, change out the arrester and/or disconnector, climb down, and finally re-energize the line. This entire process can take several hours or more, and exposes the lineman to considerable risk, especially if the line was not powered down correctly.

A first aspect of the present disclosure provides an arrester assembly including a first support member and a constant tension spring including a first end and a second end. The first end is mechanically coupled to the first support member such that the second end of the constant tension spring extends in a downward direction. The arrester assembly further includes a disconnector assembly that is electrically connected to the second end of the constant tension spring, a ground connector that is electrically connected to a ground, and an arrester that is electrically connected between the disconnector assembly and the ground connector.

A second aspect of the present disclosure provides an arrester assembly including a cutout bracket including a first connector and a second connector, a disconnector assembly electrically connected to the first connector, and an arrester electrically connected to the second connector. The arrester assembly further includes a hot stick loop connected to one or more of the disconnector assembly and the arrester, the hot stick loop including an aperture that is configured to engage a hot stick.

Other aspects of the disclosure will become apparent by consideration of the detailed description and accompanying drawings.

### BRIEF DESCRIPTION OF THE DRAWINGS

FIG. 1 illustrates a side view of an arrester assembly in accordance with the disclosure.

FIG. 2 illustrates a perspective view of a hot stick in accordance with the disclosure.

FIG. 3 is a perspective view of a ground clamp included in the arrester assembly of FIG. 1.

FIG. 4 is a perspective view of a bracket included in the arrester assembly of FIG. 1.

FIG. 5 is a perspective view of a configurable mount included in the arrester assembly of FIG. 1.

FIG. 6 is a perspective view of a spring mount included in the arrester assembly of FIG. 1.

FIG. 7 is a perspective view of a spring clip included in the arrester assembly of FIG. 1.

FIG. 8 is side view of the arrester assembly of FIG. 1 in an operated state.

FIG. 9 is a perspective view of a hot stick loop included in the arrester assembly of FIG. 1.

FIG. 10 is a side view of a disconnector assembly included in the arrester assembly of FIG. 1.

FIG. 11 is an exploded view of the disconnector assembly of FIG. 10, the overvoltage protection assembly including a disconnector assembly according to one embodiment and having a disconnecting device.

FIG. 12 is a perspective view of the disconnect device of FIG. 11.

FIG. 13 is a cross-sectional view of the disconnect device of FIG. 11 taken along the line 4-4 of FIG. 12.

FIG. 14 is a side view of the disconnector assembly of FIG. 11 in an unextended position.

FIG. 15 is a cross-sectional view of the disconnect device of FIG. 11 taken along the line 6-6 of FIG. 14.

FIG. 16 is a side view of the disconnector assembly of FIG. 11 in an extended position.

FIG. 17 is a cross-sectional view of the disconnector device of FIG. 11 taken along the line 8-8 of FIG. 16.

FIG. 18 is a side view of an arrester assembly.

### DETAILED DESCRIPTION

Before any embodiments of the disclosure are explained in detail, it is to be understood that the disclosure is not limited in its application to the details of construction and the arrangement of components set forth in the following description or illustrated in the attendant drawings. The disclosure is capable of other embodiments and of being practiced, or carried out, in various ways. Also, it is to be understood that the phraseology and terminology used herein is for the purpose of description and should not be regarded as limiting. Use of terms such as “including” and “comprising”, and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

In general, the present disclosure relates to a replaceable surge arrester assembly that includes a disconnector device configured to prevent current arcing during failure of the arrester. In some embodiments, the disconnector and/or other components of the surge arrester assembly prevent sparks, and other flammable materials, from falling to the ground and on other electrical equipment after the disconnector device is operated.

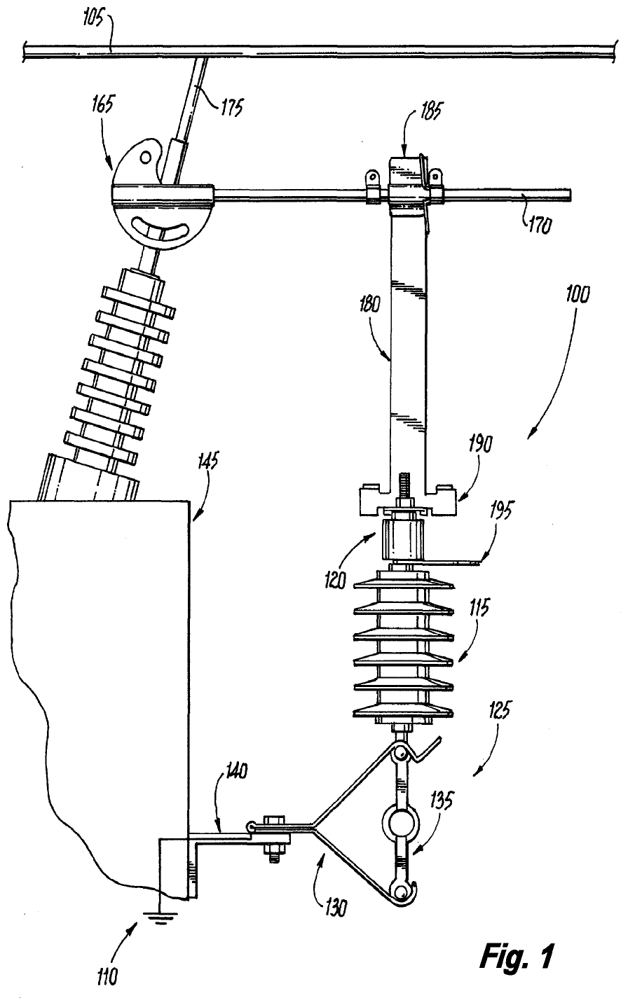

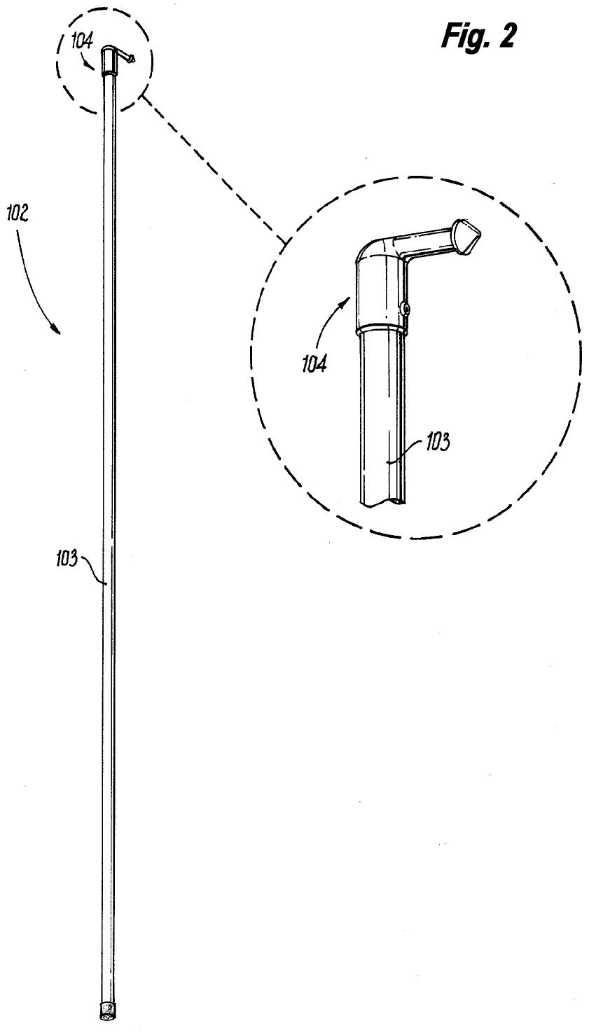

FIG. 1 illustrates a perspective view of a surge arrester assembly, or arrester assembly, 100 that can be replaced from below, according to some embodiments. For example, the surge arrester assembly 100 can be replaced by a service technician located on the ground below the arrester assembly 100. FIG. 2 illustrates an exemplary embodiment of a hot stick 102 that may be used by a service technician to replace, install, and/or otherwise interact with one or more components of the arrester assembly 100 while the service technician is located beneath the arrester assembly 100. As shown, the hot stick 102 includes a pole portion 103 and a head portion 104 that is configured to engage one or more components of the arrester assembly 100. It should be understood that the illustrated embodiment of hot stick 102 is shown and described for illustrative purposes, and thus, does not in any way limit the scope of the arrester assembly 100 described herein. Moreover, other types of hot sticks and/or similar tools may be used in combination with the surge arrester assembly 100 described herein.

The surge arrester assembly 100 is connected between a line conductor 105 and electric ground 110. The line conductor 105 may be, for example, a phase conductor that conducts electrical current and is included in an electric grid or some other electrical system. As shown, the arrester assembly 100 includes a surge arrester, or arrester, 115, a disconnector 120, and one or more pieces of mounting hardware that are configured to physically support the arrester 115 and disconnector 120. The mounting hardware is designed such that it can be reused when the arrester 115 and/or the disconnector 120 need to be replaced. That is, as described below, when one or more of the arrester 115 and the disconnector 120 experience a failure and need to be replaced, the mounting hardware included in arrester assembly 100 does not need be replaced when installing a new arrester 115 and/or a new disconnector 120. Rather, the existing mounting hardware of arrester assembly 100 is reused to install a new arrester 115 and/or a new disconnector 120, thereby simplifying the installation process and reducing costs that would otherwise be incurred by replacing old mounting hardware with new mounting hardware. Although the illustrated embodiment shows the disconnector 120 as being electrically connected between the line conductor 105 and arrester 115, it should be understood that other connection arrangements are possible. For example, in some embodiments, the disconnector 120 is connected between ground 110 and the arrester 115.

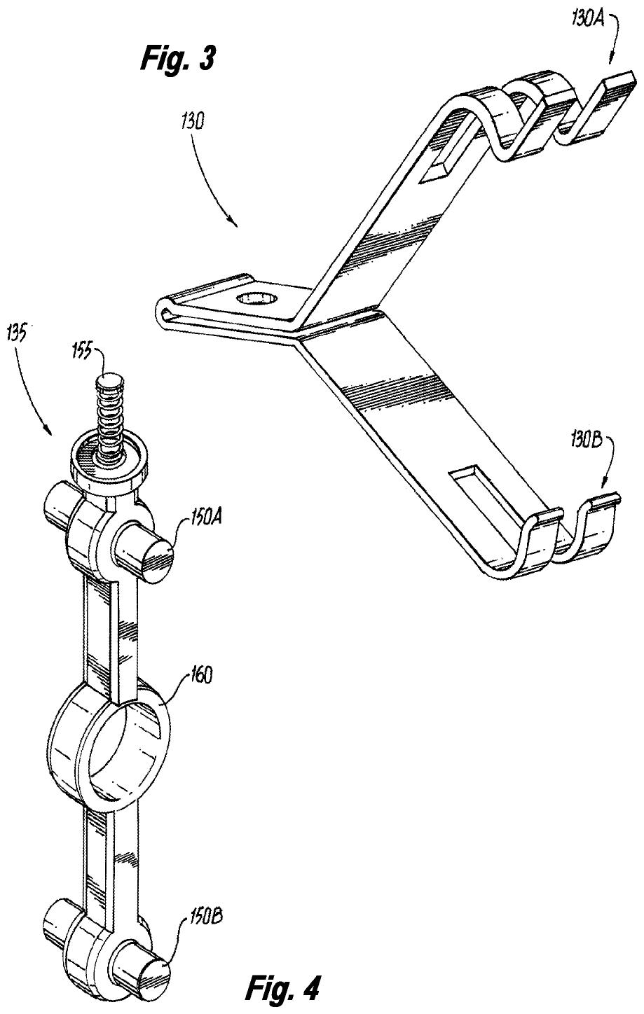

In the illustrated embodiment, the mounting hardware includes a ground connector 125 that both physically supports the arrester assembly 100 and electrically connects the arrester assembly 100 to ground 110. The ground connector 125 includes a ground clamp 130 and ground bracket 135. As shown in FIG. 3, the ground clamp 130 includes a top clamping portion 130A and a bottom clamping portion 130B. The ground clamp 130 is mounted, by a bracket 140, to the power equipment 145 (e.g., a transformer) that is protected by arrester assembly 100. The ground clamp 130 is constructed from a durable conducting material, such as but not limited to aluminum, steel, and high-strength alloys, and provides an electrical connection between ground 110 and the arrester 115. Furthermore, the spring tension of the ground clamp 130 provides mechanical support for the arrester 115.

When the arrester assembly 100 is installed in the configuration illustrated in FIG. 1, the ground bracket 135 is electrically connected to the bottom of arrester 115, thereby providing mechanical support for the arrester 115. As shown, the ground bracket 135 is mechanically connected to the bottom of arrester 115 and provides physical support for the arrester 115 in an upright position. Furthermore, the ground bracket 135 electrically connects the arrester 115 to ground 110. In some embodiments, the ground bracket 135 is constructed from the same durable conducting material that is used to construct the ground clamp 130. In such embodiments, the ground bracket 135 conducts current that flows from the arrester 115 to the ground 110.

FIG. 4 illustrates a perspective view of the ground bracket 135. As shown, the ground bracket 135 includes upper connecting pins 150A that are arranged to mate with the top clamping portion 130A of ground clamp 130 and lower connecting pins 150B that are arranged to mate with the bottom clamping portion 130B of ground clamp 130. The ground bracket 135 may be connected to the ground clamp 130 using a snap fit connection (e.g., by snapping the ground bracket 135 into the ground clamp 130) that is secured by the spring tension of the ground clamp 130. That is, the spring tension of the ground clamp 130 presses on the upper and lower connecting pins 150A, 150B to hold the ground bracket 135 in an upright position. The ground bracket 135 also includes a top conductor 155 that connects the ground bracket 135 electrically and mechanically to the bottom of arrester 115. In the illustrated embodiment, the top conductor 155 includes a conductive spring that is configured to press against a bottom surface of arrester 115. In some embodiments, the top conductor 155 does not include a spring. In such embodiments, the top conductor 155 may be rigid and arranged to press against the bottom surface of the arrester 115.

The ground bracket 135 further includes a loop 160 formed within. The loop 160 is shaped such that it can receive the end of a hot stick 102, or similar tool, used by a technician to move and/or replace the arrester 115. The loop 160 provides a technician with the ability to physically manipulate (e.g., raise, lower, adjust, etc.) the position of arrester 115 with a hot stick 102 while the service technician stands on the ground below. For example, while standing on the ground, a service technician may insert the end of a hot stick 102 into the loop 160 when disconnecting and/or removing a damaged arrester 115 from the arrester assembly 100. Similarly, while standing on the ground, a service technician may insert the end of a hot stick 102 into the loop 160 when installing a new arrester 115 into the arrester assembly 100. Given the snap-fit connection between the ground clamp 130 and the ground bracket 135, a technician does not need to remove the ground clamp 130 from the bracket 140 when making such adjustments. Rather, the ground clamp 130 can remain in place as the technician manipulates the position of ground bracket 135 using the hot stick 102.

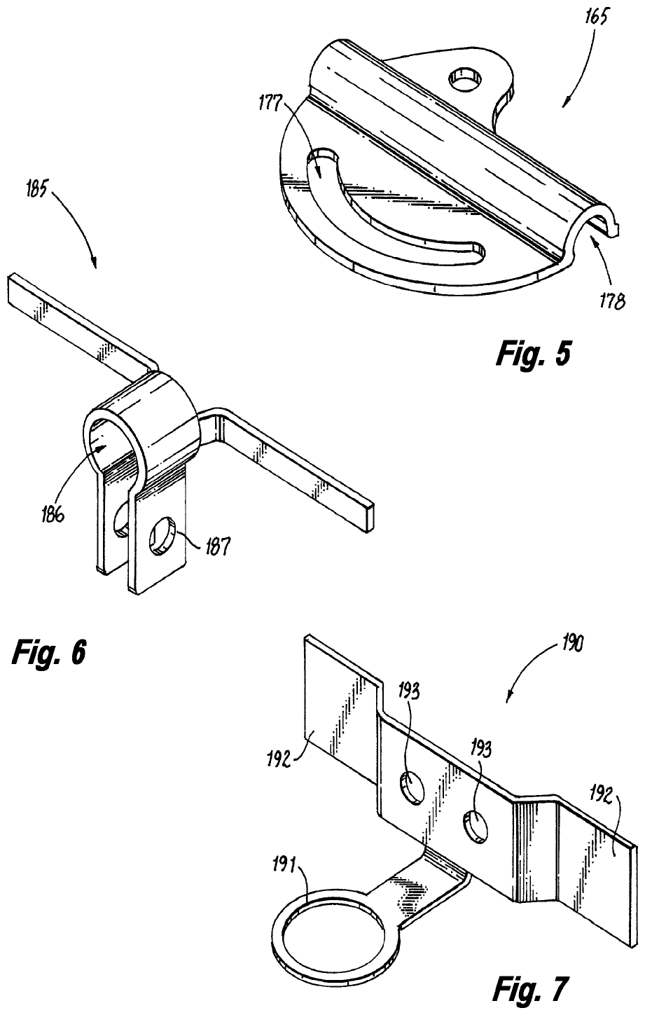

The mounting hardware for surge arrester assembly 100 further includes components that are used to connect the arrester assembly mechanically and electrically 100 to the line conductor 105. As shown in FIG. 1, the arrester assembly 100 includes a configurable mount 165 that supports a first rod 170 that is electrically connected to the components of the arrester assembly 100 and a second rod 175 that is electrically connected to the line conductor 105. The configurable mount 165 may be physically supported by the electrical equipment 140 and/or some other nearby structure. FIG. 5 illustrates a perspective view of the configurable mount 165, which includes an arc shaped opening 177 that allows for the angle at which the configurable mount 170 is installed to be adjusted. For example, using the arc shaped opening 177 and accompanying fasteners, the configurable mount 165, first rod 170, and second rod 175 may be arranged in any mounting configuration within a spherical envelope. Although described and illustrated as rods, it should be understood that in some embodiments, the first and second rods 165, 170 may be implemented using other hardware components.

When installed, first rod 170 is supported in a horizontal position by the configurable mount 165. In some embodiments, the first rod 170 is clamped by the configurable mount 165, and in other embodiments, the first rod 170 is received by an aperture 178 included in the configurable mount 170. In some embodiments, the first rod 170 is constructed from a durable conductive material, such as but not limited to, aluminum, steel, and/or high-strength alloys. In some embodiments, the first rod 170 is coated with an insulating resin. In some embodiments, the first rod 170 is solid and conducts current from the line conductor 105 to the arrester assembly 100. In other embodiments, the first rod 170 is hollow and allows a conducting wire that connects the line conductor 105 to the arrester assembly 100 to pass within.

As shown in FIG. 1, a constant tension spring 180 is mechanically connected to and supported by the first rod 170. In particular, a first end of the constant tension spring 180 is mounted to the first rod 170 by a spring mount 185. FIG. 6 illustrates a perspective view of the spring mount 185. As shown, the spring mount 185 includes a circular opening 186 for coupling to the first rod 170. For example, the circular opening 186 may be arranged to fit around the circumference of the first rod 170 such that the spring mount 185 can be moved (e.g., slid) back and forth along the length of the first rod 170 when repairing the arrester assembly 100. The spring mount 185 further includes apertures 187 that are arranged to receive one or more mechanical fasteners used to couple the constant tension spring 180 to the spring mount 185. In some embodiments, the spring mount 185 is constructed from a durable conductive material, such as aluminum, steel, or high-strength alloys. In some embodiments, the exterior of the spring mount 185 is coated with an insulating material.

In some embodiments, the constant tension spring 180 also electrically connects the disconnector 120 to the first rod 170. That is, in some embodiments, the constant tension spring 180 is constructed from a conductive material that conducts current from the first rod 170 to the disconnector 120. For example, the constant tension spring may be constructed from one or more durable conductive materials, such as but not limited to aluminum, steel, and high-strength alloys. In other embodiments (not shown), the constant tension spring 180 supports a conductive wire that is connected between the first rod 170 and the disconnector 120. In such embodiments, the conductive wire may extend downward from the first rod 170 and along the body of the constant tension spring 180 towards the disconnector 120.

In some embodiments, such as the illustrated embodiment of FIG. 1, the constant tension spring 180 is mechanically coupled to the disconnector 120 by one or more mechanical fasteners, such as a bolted connection. In such embodiments, the constant tension spring 180 includes and/or is otherwise coupled to a spring clip 190 that is bolted to the top of disconnector 120. FIG. 7 illustrates a perspective view of the spring clip 190. As shown, the spring clip 190 includes an aperture 191 that is arranged to receive the mechanical fastener(s) (e.g., a bolt) used to couple the disconnector 120 to the constant tension spring 180. Furthermore, the spring clip 190 includes extending members 192 that protrude outward and are arranged to be engaged by a hot stick, or similar tool, used by a service technician standing below the arrester assembly 100. For example, when a service technician engages the extending members 192 of spring clip 190 with a hot stick 102, the service technician is able to lower the constant tension spring 180 into place when installing a new arrester 115 and/or a new disconnector 120. In other embodiments, the spring clip 190 includes a hook or similar feature for detachably engaging the disconnector 120. In some embodiments, the spring clip 190 includes spring apertures 193 for fastening the spring clip 190 to the constant tension spring 180.

When the surge arrester assembly 100 is operating under normal conditions (e.g., non-fault conditions in which the disconnector 120 has not separated the arrester 115 from line conductor 105), the constant tension spring 180 is under a constant tension when connected between the disconnector 120 and first rod 170 as shown in FIG. 1. However, when an electrical fault (e.g., overcurrent, over temperature, power surge, etc.) occurs that causes the arrester 115 to fail and/or the disconnector 120 to operate (e.g., detonate explosive material contained within), the disconnector 120 electrically and mechanically disconnects the arrester 115 from the line conductor 105.

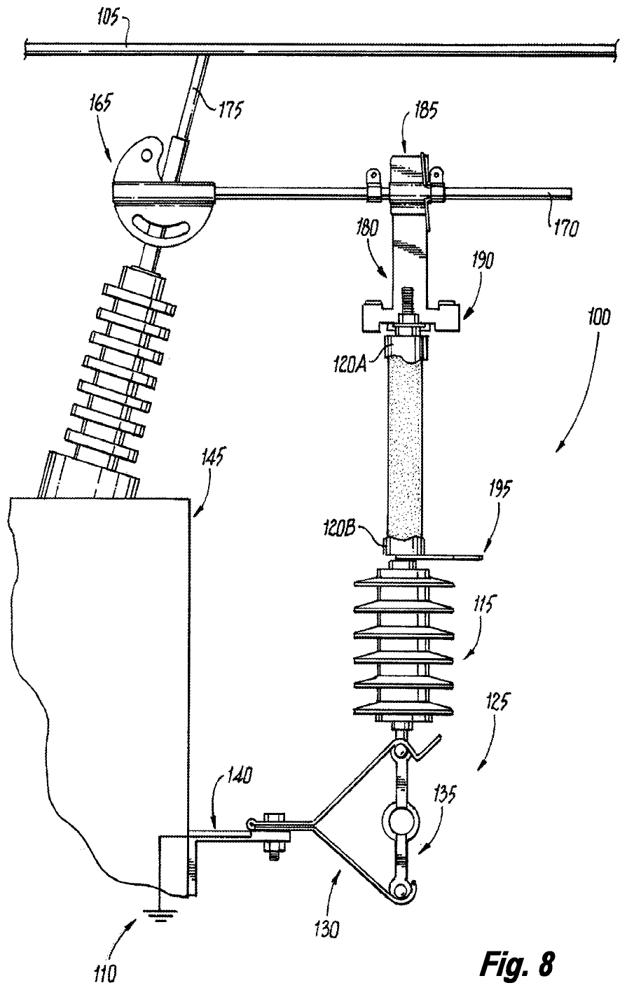

Upon operation of the disconnector 120, the tension on the constant tension spring 180 is released thereby causing the constant tension spring 180 to retract vertically upwards towards the first rod 170. FIG. 8 illustrates a scenario in which an electrical fault has occurred and the disconnector 120 has performed an operating action (e.g., a detonation). After operation, the disconnector 120 is broken into multiple pieces that include a first disconnector piece 120A that remains connected to the constant tension spring 180 and a second disconnector piece 120B that remains connected to the arrester 115. As shown and described, the constant tension spring 180 retracts vertically upwards to the first rod 170, thereby separating the first disconnector piece 120A from the second disconnector 120B. The separation between the first and second disconnector pieces 120A, 120B is large enough to prevent current from flowing and/or arcing between the first and second disconnector pieces 120A, 120B. For example, the constant spring tension 180 may be designed such that retraction of the constant spring 180 separates the first disconnector piece 120A from the second disconnector piece 120B by a length that satisfies standardized safety requirements.

Although arrester assembly 100 is illustrated and described as including a constant tension spring 180 that is used to connect the first rod 170 to the disconnector 120 and/or arrester 115, it should be understood that in some embodiments, other mechanical components may be used to connect the first rod 170 to the disconnector 120 and/or arrester 115. For example, in some embodiments, other types of springs may be used to connect the first rod 170 to the disconnector 120 and/or arrester 115. In some embodiments, a loose hanging wire may be used to connect the first rod 170 to the disconnector 120 and/or the arrester 115. In some embodiments, a rigid mechanical component, such as a rod or bracket, may be used to connect the first rod 170 to the disconnector 120 and/or the arrester 115.

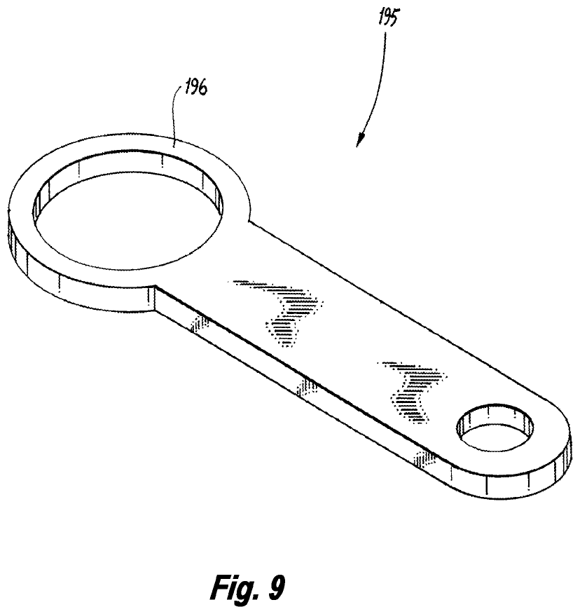

In some embodiments, the mounting hardware included in arrester assembly 100 further includes a hot stick loop 195 that is mechanically coupled to the top of arrester 115 and/or the bottom of disconnector 120. FIG. 9 illustrates a perspective view of the hot stick loop 195, which includes an aperture, or loop, 196 that is arranged to receive a hot stick 102 or similar tool used by a service technician standing below the arrester assembly 100. For example, a service technician may engage the hot stick loop 195 with a hot stick 102 when removing a damaged arrester 115 and/or a damaged disconnector 120 from the arrester assembly 100. Likewise, a service technician may engage the hot stick loop 195 with a hot stick 102 to raise and/or lower a new arrester 115 and/or disconnector 120 into place when installing a new arrester 115 and/or a new disconnector 120 into the arrester assembly 100.

As described above, the disconnector 120 contains explosive material that detonates upon failure of the arrester 115 caused by an electrical fault such as an overcurrent fault, an overtemperature fault, a voltage fault, or other type of fault. Upon detonation of the disconnector 120, explosive debris may propel outward from the disconnector 120 and current arcing may occur between the first disconnector piece 120A and the second disconnector piece 120B. Unless the explosive debris and/or current arcing is contained, the mounting hardware and electrical equipment 140 nearby the disconnector 120 may get damaged. As described above, the hardware for surge arrester assembly 100 is intended to be reused when damaged arresters 115 and/or disconnectors 120 are replaced with new ones. Accordingly, in some embodiments, the disconnector 120 is designed to contain the explosive debris and/or current arcing caused by detonation of the disconnector 120, thereby protecting the nearby mounting hardware and electrical equipment 140 from being damaged.

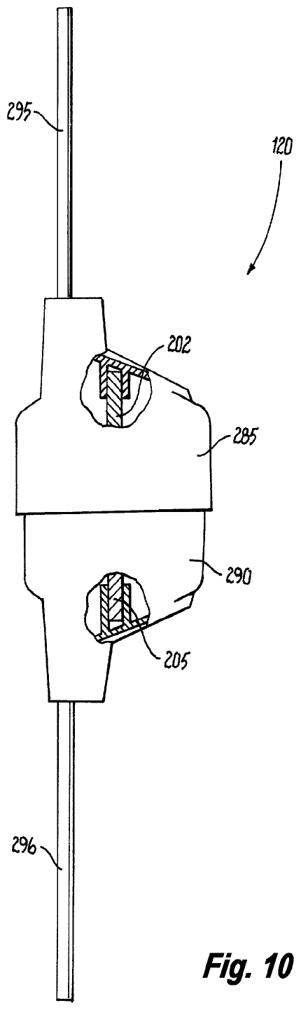

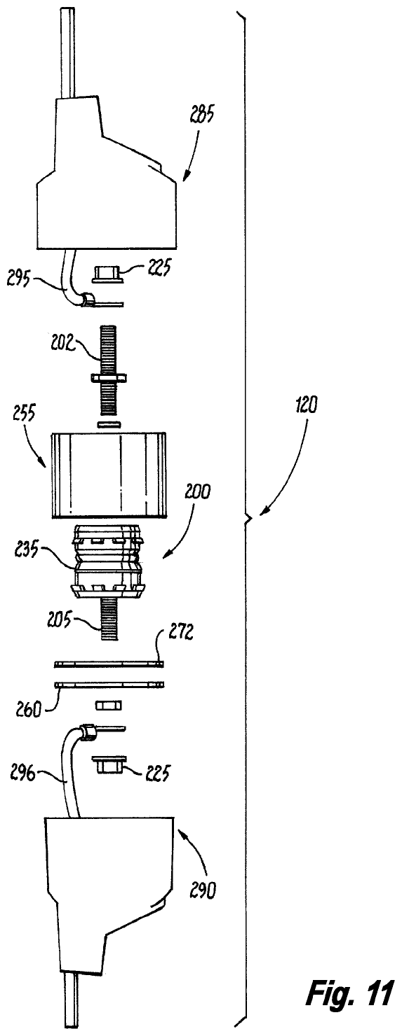

FIGS. 10-17 illustrate an embodiment of the disconnector, or disconnector assembly, 120 that is configured to prevent damage from being caused to the mounting hardware and electrical equipment 140. It should be understood that the embodiment of disconnector 120 illustrated in FIGS. 10-17 does not limit the scope of arrester assembly 100. Accordingly, other types of disconnectors that include components capable of preventing the projection of explosive debris and/or current arcing may be used to implement disconnector 120. For example, disconnector 120 may be implemented as any one of the disconnector assemblies described in U.S. patent application Ser. No. 16/862,052, filed Apr. 29, 2020 and entitled “DISCONNECTOR DEVICE AND OVERVOLTAGE PROTECTION ASSEMBLY INCLUDING THE SAME,” the entire content of which is hereby incorporated by reference and reproduced in part below.

As shown in FIGS. 10-17 the disconnector 120 includes a disconnect device 200. The disconnect device 200 includes a charge housing or insulator 201 containing a charge (e.g., an explosive charge—not shown) coupled to a first electrical lead or upper stud 202 and a second electrical lead or lower stud 205. The upper stud 202 may be used to mechanically and/or electrically connect the disconnector 120 to the constant tension spring 180 as described above. For example, the upper stud 202 may be mechanically and/or electrically coupled to the spring clip 190. Similarly, the lower stud 205 may be used to mechanically and/or electrically connect the disconnector 120 to the arrester 115 as described above. In some embodiments, the hot stick loop 195 is mechanically coupled to the lower stud 205. In the illustrated embodiment, the upper and lower studs 202, 205 are made from an electrically conductive material (e.g., metal) and may provide electrical communication to the charge included in insulator 201.

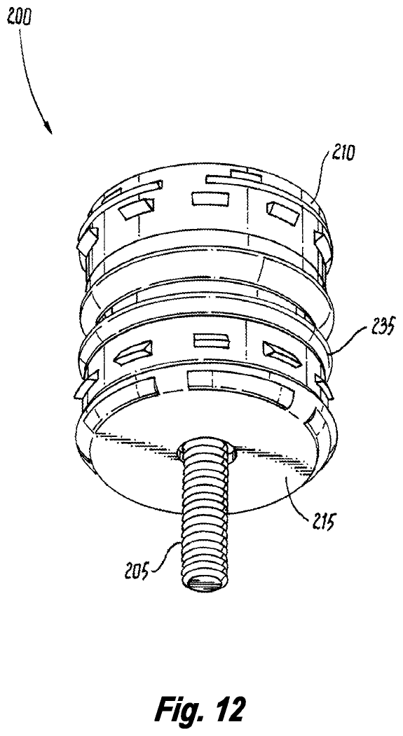

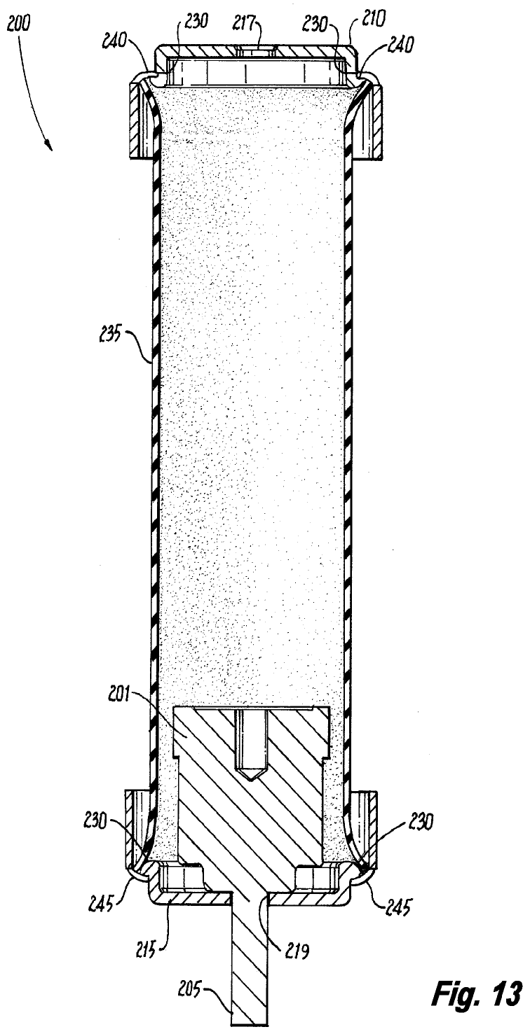

As shown in FIGS. 12-15, a first plate 210 (e.g., first connector or upper sleeve connector) is coupled to the upper stud 202, and a second plate 215 (e.g., second connector or lower sleeve connector) is coupled to the lower stud 205. An opening 217, 219 in each upper and lower sleeve connector 210, 215 is aligned with the respective stud 202, 205, enabling the upper and lower sleeve connectors 210, 215 to be positioned around the studs 202, 205. In the illustrated embodiment, the studs 202, 205 are threaded and nuts 220, 225 (see e.g., FIG. 11) may be used to secure the respective upper and lower sleeve connector 210, 215, and limit relative movement with respect to the respective stud 202, 205. Each of the upper and lower sleeve connectors 210, 215 may also include a groove 230 (FIG. 13) that extends along a circumference of the respective upper and lower sleeve connectors 210, 215.

As shown in FIGS. 11-13, 15, and 17, in some embodiments, a sleeve 235 (e.g., a fire-resistant sleeve) is positioned around the insulator 201 and is coupled to the each of the upper and lower sleeve connectors 210, 215. That is, the upper sleeve connector 210 and the lower sleeve connector 215 are also coupled via the sleeve 235. In the illustrated embodiment, a respective end of the sleeve 235 is positioned within the groove 230 of the respective upper and lower sleeve connectors 210, 215. Retaining members 240, 245 (e.g., clips—FIG. 13) are positioned over top of the ends of the sleeve 235 and around the groove 230 to couple the sleeve 235 to the connectors 210, 215. The sleeve 235 is flexible so that it is collapsible (e.g., contractable) and expandable (e.g., extendable). The insulator 201 may be further enclosed by an arc quenching material 250, which is contained by the upper and lower sleeve connectors 210, 215 and the sleeve 235. In some embodiments, the arc quenching material 250 of the disconnector device 200 may extinguish electrical arcs at current levels of 20 kA or less. In some embodiments, the arc quenching material 250 of the disconnector device 200 may extinguish electrical arcs at current levels of 30 kA to 50 kA. The arc quenching material 250 may extinguish electrical arcs at other values. In other embodiments, the sleeve 235 may be omitted.

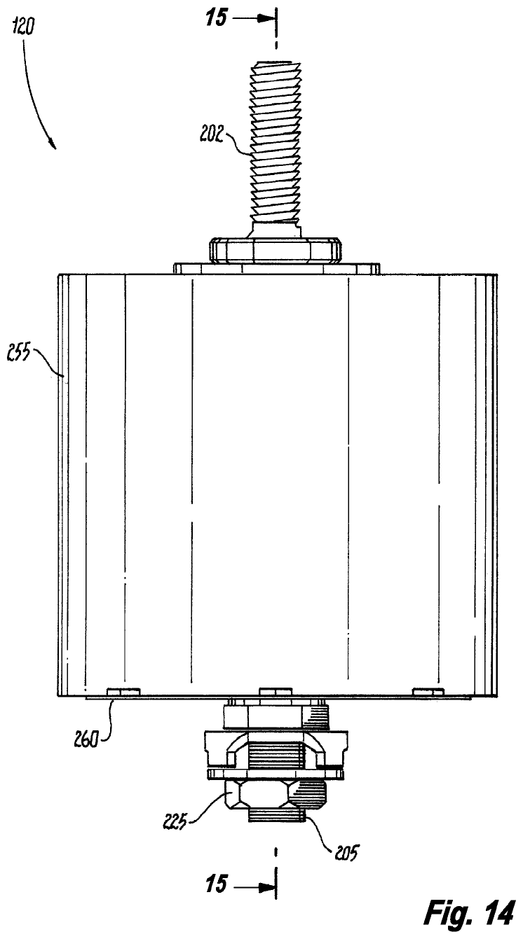

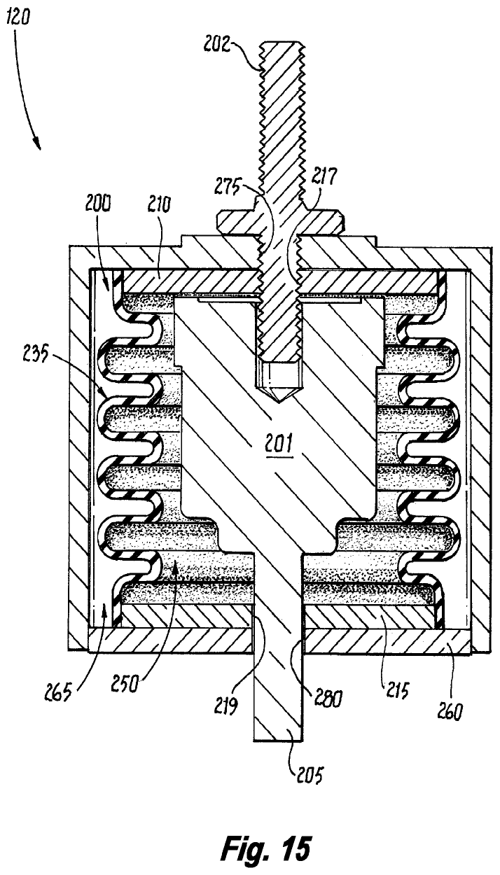

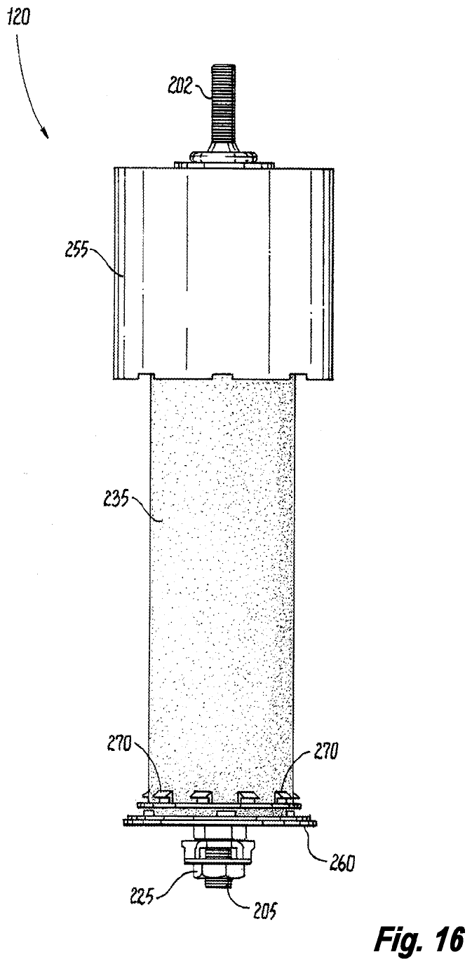

As shown in FIGS. 14 and 15, the disconnector device 200 is positioned within a housing to form the disconnector 120. The housing is made up of a first housing member or cap 255 and a second housing member or bottom cover 260. The bottom cover 260 is removably coupled to the cap 255, and a cavity or chamber 265 is defined between the cap 255 and the cover 260. The chamber 265 is sized to receive the disconnector device 200 and the sleeve 235 when it is collapsed or unextended. That is, the sleeve 235 is longer the distance between the upper and lower sleeve connectors 210, 215 when both are positioned within the cavity 265. In some embodiments, the bottom cover 260 is loosely coupled to the cap 255. In other words, the bottom cover 260 is not permanently fixed to the cap 255 but cannot move relative to the cap 255 without applying a substantial amount of force (e.g., more than the force of gravity). For example, in the illustrated embodiment, the cover 260 is coupled to cap 255 using a snap fit. In other embodiments, the cap 255 and cover 260 may be coupled in a different manner. For example, in the illustrated embodiment, the bottom cover 260 has plurality of teeth 270 (FIG. 16) that engage the cap 255 to hold the sleeve in place during the motion of cover 260. A gasket 272 (FIG. 11) is positioned between the cap 255 and the cover 260. The first housing helps protect the disconnect device 200 from weather (e.g., rain, snow, etc.).

The cap 255 and the bottom cover 260 each include an opening 275, 280 (FIG. 15) that receive the respective stud 202, 205. The studs 202, 205 extend through the openings 275, 280, so that a length of each stud 202, 205 remains exposed for respectively coupling to the constant tension spring 180 and the arrester 115. The cap 255 and bottom cover 260 are each secured to the respective stud 202, 205 in order to limit relative movement between the cap 255, bottom cover 260, and respective stud 202, 205.

In the embodiments of FIGS. 10-15, an auxiliary or outer housing encloses the disconnector 120. As shown in FIGS. 10-11, the outer housing includes a first or upper housing part 285 and a second or lower housing part 290 that enclose the disconnector 120. The first and second housing parts 285, 290 are removably coupled (e.g., by a push on connection or the like) to one another. In the illustrated embodiment, the top stud 202 is in electrical communication with an electrical wire 295 that extends through an opening (not shown) in the upper housing part 285 to electrically connect to the constant tension spring 180. However, as described above, the top stud 202 may be connected directly to the constant tension spring 180 (e.g., via the spring clip 190). In the illustrated embodiment, the bottom stud 205 is in electrical communication with an electrical wire 296 that extends through an opening (not shown) in the lower housing part 290 to electrically connect to arrester 115. However, as described above, the lower stud 205 may be connected directly to the arrester 115 without a need for wire 296. The outer housing helps to prevent access by humans and wildlife to the electrical components housed within and protects the electrical components from being tampered with by humans and wildlife.

As shown in FIGS. 14-15, the disconnector 120 includes a closed configuration in which the sleeve 235 is in a collapsed or unextended position between the upper and lower sleeve connectors 210, 215. That is, when the disconnector 120 is in the closed configuration, the bottom cover 260 is coupled to the cap 255, and the sleeve 235 is folded or collapsed such that it fits in the chamber 265 formed by the cap 255 and the bottom cover 260. Accordingly, as shown, the insulator 201, the upper and lower sleeve connectors 210, 30, and the sleeve 235 are positioned within the chamber 265.

Although the disconnector 120 is typically in a closed configuration, a condition may be met such that the disconnector 120 performs an operating function as described. This condition may be, for example, reaching a temperature threshold, a leakage current, an overvoltage threshold, an overcurrent threshold, an arrester failure or the like. The operating function may be, for example, a movement such that the cap 255 and the cover 260 are separated. However, separation of the cap 255 and the cover 260, as well as the first and second housing parts 285, 290, is preferably minimal, such that strain is not placed on the electrical device 100. The operating function may also be an action that breaks or disables a component (e.g., the insulator 201) of the disconnector 102. For example, the charge of the insulator 201 may include a cartridge containing gunpowder. When high temperature, high voltage, or high current are sustained, the gunpowder within the cartridge is ignited, causing an explosion that forces the cap 255 and the cover 260 apart, breaking the electrical connection. Alternatively, the gunpowder may ignite based on a leakage current through the arrester 115 exceeding a safe amount. As described above, the constant tension spring 180 retracts vertically upwards towards the first rod 170 upon the explosion of the charge included in insulator 201.

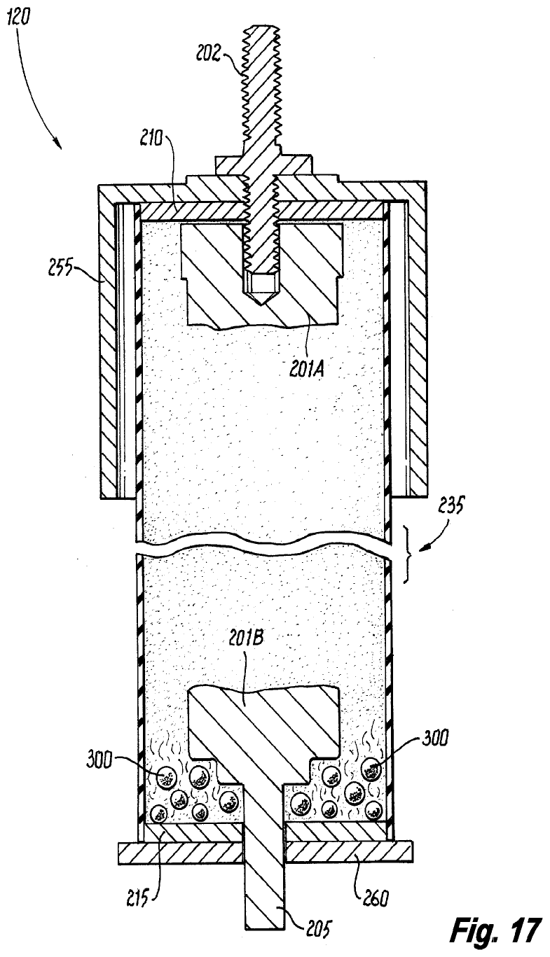

One embodiment of operation of the disconnector 120 may be as follows. When a fault (e.g., leakage current, overcurrent, over voltage, overtemperature, etc.) occurs within the electrical system to which line conductor 105 is connected and/or within the arrester 115, the electrical device 100 experiences a fault condition. Accordingly, current from the line conductor 105 flows through the disconnector 120, and specifically, the disconnector device 200, towards ground 110. While current flows through the disconnect device 200, the disconnect device 200 begins to heat up. That is, excess heat will build up in the disconnector assembly 120, and specifically within the insulator 201. Once a temperature threshold has been reached, the disconnect device 200 operates such that current flow from the line conductor 105 to the ground 110 is interrupted. As shown in FIGS. 16 and 17, this excess heat will eventually cause the charge included in disconnect device 200 to detonate, and the arrester 115 and the fault condition will be isolated from the rest of the system.

Further with reference to FIGS. 16 and 17, the force from the explosion also exerts a force on the cap 255 and the bottom cover 260. This force is greater than a coupling force between the cap 255 and the bottom cover 260 and causes the bottom cover 260 to uncouple or break apart from the cap 255. Similarly, this force is greater than a coupling force between the upper and lower housing parts 285, 290, and causes the lower housing part 290 to uncouple or break apart from the upper housing part 285. As the cover 260 and the lower housing part 290 are forced away from the cap 255 and upper housing part 285, the sleeve 235 extends to its full length in an extended or expanded position. The detonation of the charge causes the insulator 201 to fracture into a first section or top insulator 201A and a second section or bottom insulator 201B.

FIGS. 16 and 17 also illustrate the disconnector 120 in an operated configuration (after the charge has detonated). The lower sleeve connector 215, cover 260 and the bottom stud 205 have moved in a direction substantially parallel to the top stud 202 and perpendicular to upper sleeve connector 210. In the operated configuration, the cap 255 and the cover 260 are not coupled and in fact are spaced apart from one another. Thus, in the operated position, the upper sleeve connector 210 and the lower sleeve connector 215 are separate such that the sleeve 235 has been extended. Also, the top insulator 201A remains connected to the top stud 202 and the top sleeve connector 210 and the bottom insulator 201B remains connected to the bottom stud 205 and the bottom sleeve connector 215.

When the disconnector 120 is in the operated configuration, this electrical connection is broken. In other words, the detonation of the charge breaks electrical contact between the energized contact of the line conductor 105 and ground 110. While the studs 202, 205 remain electrically connected to the energized contact of the line conductor 105 via constant tension spring 180 and the ground 110 via arrester 115, respectively, the fracturing of the insulator 201 into top and bottom insulators 201A, 201B and the separation of the bottom cover 260 from the cap 255 creates an open circuit. As shown in FIG. 17 and noted above, each top and bottom insulators 201A, 201B remains connected to its respective stud 202, 205, but the top and bottom insulators 201A, 201B are not in contact and no current may pass between them. The open circuit prevents the system from faulting to ground 110 after being energized without being removed.

Electrical arcing occurs when the electrical contact is broken between the energized contact of the line conductor 105 (e.g., the first rod 170 or the constant tension spring 180) and ground 110. In order to prevent or limit electrical arcing, circuit breakers (not shown) may be placed within the system to stop the flow of power to the upper stud 202. Once the flow of power stops, an arc can no longer be sustained between the top and bottom insulators 201A, 201B. Moreover, the distance between the fractured housings 201A, 201B is then too great for another arc to form. In some embodiments, the insulator 201 may also have (e.g., be made with, be coated with, etc.) an arc quenching material, which may suppress the arc produced as a result of the broken electrical contact. Suppressing the arc results in fewer hot or burning particles 300 as a result of the explosion. In the illustrated embodiment, alumina trihydrate (ATH) may be used as the arc quenching material, although different materials may also be used.

Particles 300 are created as a result of both the explosion and subsequent fracturing of the charge housing, as well as the electrical arcing that may occur. These particles 300 are often hot or burning. As noted above, the sleeve 235 is designed to be heat resistant so that the explosion and the particles 300 do not destroy the sleeve 235. For example, the sleeve 235 may be resistant to at least 500° C. In other embodiments, the sleeve 235 may be resistant to at least 600° C. In some embodiments, the sleeve 235 captures all these particles 300 in order to prevent or substantially limit the number of particles 300 that fall to the ground. By containing the particles 300 within the sleeve 235, fires may be prevented.

The disconnection of the upper and lower housing parts 285, 290 may provide a visual indication of a fault condition having occurred. The sleeve 235 may also provide a visual indication of a fault condition having occurred. The extended position of the sleeve 235 may make it easier for an operator to identify where the fault occurred, so that the arrester assembly 100 can be repaired. Additionally, the sleeve 235 may be made from a bright color (e.g., yellow, red, orange, or the like) that is visible for a long distance away, in order to further assist the operator in identifying where the fault occurred.

Accordingly, when disconnector 120 included in the arrester assembly 100 is implemented as a disconnector that includes a protective sleeve 235 and other protective components described herein and shown in FIGS. 10-17, the electrical equipment 140 and mounting hardware of arrester assembly 100 may be protected from arcing damage and/or fire hazards upon operation of the disconnector 120. Furthermore, as described above, the disconnector 120 may be implemented using other types of disconnector devices not explicitly described herein.

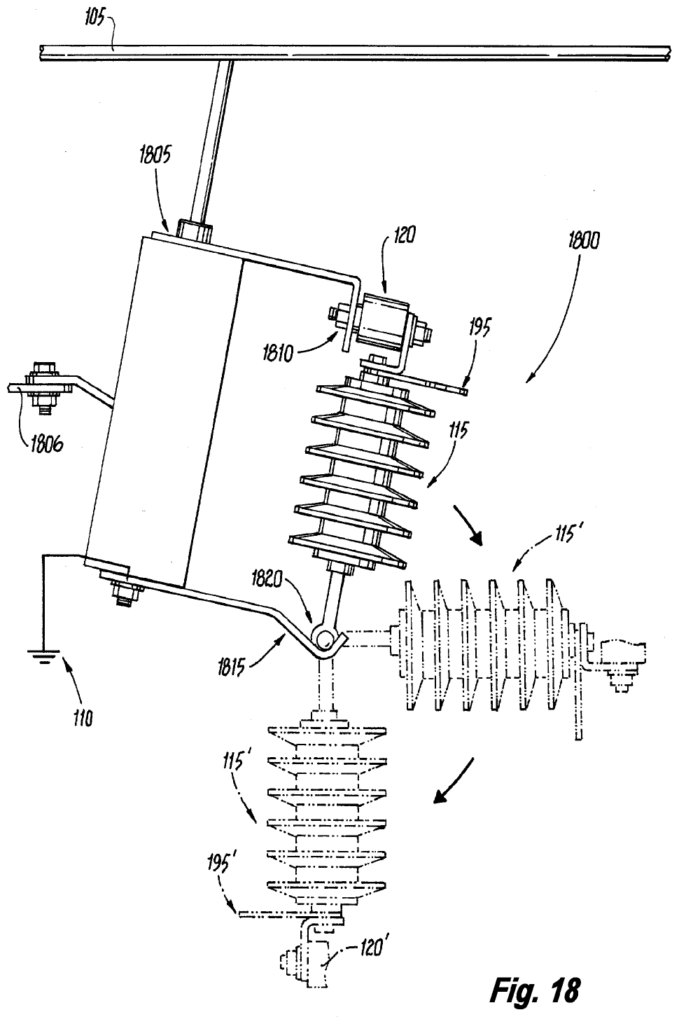

FIG. 18 illustrates an embodiment of a surge arrester assembly, or arrester assembly, 1800. The arrester assembly 1800 may be similar in configuration to that of arrester assembly 100 described herein. Moreover, some of the components included in the arrester assembly 1800 may be the same as components included in arrester assembly 100. For example, arrester assembly 1800 includes an arrester 115 that is the same as, or similar to, the arrester 115 included in arrester assembly 100. Likewise, arrester assembly 1800 includes a disconnector 120 that is the same as the disconnector 120 included in arrester assembly 100 and described herein with respect to FIGS. 10-17. In addition, some of the mounting hardware included in arrester assembly 1800 is similar to the mounting hardware included in arrester assembly 100. However, as will be described below with respect to FIG. 18, arrester assembly 1800 may also include mounting hardware that is not included in the arrester assembly 100.

Similar to the arrester assembly 100, the arrester assembly 1800 is designed to be replaced or otherwise serviced by a technician standing below the arrester assembly 1800. For example, a technician standing on the ground below the arrester assembly 1800 may be able to replace and/or move one or more components of the arrester assembly 1800 using a hot stick 102 or similar tool. As shown, the arrester assembly 1800 is electrically connected between a line conductor 105 and electrical ground 110. The arrester assembly 1800 includes a surge arrester, or arrester, 115, a disconnector 120, and one or more pieces of mounting hardware used to physically support the arrester assembly 1800. The mounting hardware is designed such that it can be reused when the arrester 115 and/or the disconnector 120 need to be replaced. That is, when one or more of the arrester 115 and the disconnector 120 experience a failure and need to be replaced, the mounting hardware included in arrester assembly 1800 does not need be replaced when installing a new arrester 115 and/or a new disconnector 120. Rather, the existing mounting hardware of arrester assembly 1800 is reused to install a new arrester 115 and/or a new disconnector 120, thereby simplifying the installation process and reducing costs that would otherwise be incurred by replacing old mounting hardware with new mounting hardware. Although the illustrated embodiment shows the disconnector 120 as being electrically connected between the line conductor 105 and arrester 115, it should be understood that other connection arrangements are possible. For example, in some embodiments, the disconnector 120 is connected between ground 110 and the arrester 115.

The mounting hardware includes a standardized cutout-style bracket 1805 that is configured to physically support the arrester 115 and disconnector 120. When compared to custom brackets that are used for mounting surge arresters, the standardized cutout bracket 1805 includes standardized components that are both easily replaceable and readily available. The cutout bracket 1805 may be constructed from a durable material, such as but no limited to aluminum, steel, and/or high-strength alloys. As shown, the cutout bracket 1805 is supported by a mounting bracket 1806 that may be mounted to a piece of electrical equipment or other nearby structure.

The disconnector 120 included in arrester assembly 1800 is mechanically and electrically connected to an conductor connector 1810 of the cutout bracket 1805. In some embodiments, the conductor connector 1810 is electrically conductive and provides a current path from the line conductor 105 to the disconnector 120. In other embodiments, the conductor connector 1810 supports a conducting wire that electrically connects the line conductor 105 to the disconnector 120. In some embodiments, the conductor connector 1810 includes hardware, such as an aperture or clamp, that is arranged to receive the upper stud 202 of disconnector 120, thereby forming a mechanical and/or electrical connection between the cutout bracket 1805 and the disconnector 120. In some embodiments, the disconnector 120 is bolted to the conductor connector 1810.

The mounting hardware included in arrester assembly 1800 further includes a hot stick loop 195 that is mechanically coupled to the top of arrester 115 and/or the bottom of disconnector 120. As shown, the hot stick loop 195 includes an aperture that is arranged to receive a hot stick 102 or similar tool used by a service technician standing below the arrester assembly 1800. For example, a service technician may engage the hot stick loop 195 with a hot stick 102 when removing a damaged arrester 115 and/or a damaged disconnector 120 from the arrester assembly 1800. Likewise, a service technician may engage the hot stick loop 195 with a hot stick 102 to raise and/or lower a new arrester 115 and/or disconnector 120 into place when installing a new arrester 115 and/or a new disconnector 120 into the arrester assembly 1800.

The cutout bracket 1800 further includes a ground connector 1815 that extends from a bottom surface of the cutout bracket 1800. The ground connector 1815 is electrically connected to ground 110 and provides a current path from the arrester 115 to ground 110. In some embodiments, the ground connector 1815 is electrically conductive and directs current form the arrester 115 to ground 110. In other embodiments, the ground connector 1815 supports a wire that connects the arresters 115 to ground 110. The cutout bracket 1805 and corresponding connectors 1810, 1815 may be constructed from durable conductive materials, such as but not limited to aluminum, steel, and/or high-strength alloys.

As shown, the ground connector 1815 is shaped to receive an arrester support bracket 1820 that is mechanically and/or electrically connected to the bottom of the arrester 115. In particular, the ground connector 1815 includes a circular opening, or cutout, that receives a rounded end of the arrester support bracket 1820. The arrester support bracket 1820 may be free to pivot about its rounded end when the rounded end is seated within the circular cutout of the ground connector 1815.

In addition, when the rounded end of the arrester support bracket 1820 is seated within the circular opening of the ground connector 1815, current is able to flow from the arrester 115, through the arrester support bracket 1820 and ground connector 1815, to the ground 110. In some embodiments, the rounded end of the arrester support bracket 1820 includes an aperture that is configured to be engaged by a hot stick 102. In some embodiments, the arrester support bracket 1820 is constructed from durable electrically conductive materials, such as but not limited to aluminum, steel, and/or high-strength alloys.

When the arrester assembly 1800 is operating in a normal, non-faulted state, the ground connector 1815 and arrester support bracket 1820 combine to physically support the arrester 115 in a generally upright position between the disconnector 120 and the ground connector 1815. However, when an electrical fault occurs and the disconnector 120 performs an operating act as described above (e.g., detonates explosive material contained in insulator 201), the disconnector 120 disconnects and propels away from the conductor connector 1810. Accordingly, the remnants of the disconnector 120 and the arrester 115 swing downwards in a pivoting motion about the rounded end of the arrester support bracket 1820 seated within the ground connector 1815. As shown by the phantom lines in FIG. 18, the arrester 115′ and disconnector 120′ lay suspended in air, via the arrest support member 1820, from the ground connector 1815 after operation of the disconnector 120.

A technician is able to easily replace the suspended arrester 115′ and/or the suspended disconnector 120′ using a hot stick 102. For example, while the arrester 115′ and disconnector 120′ hang suspended form ground conductor 1815 after operation of the disconnector 120, the technician need only to engage the hot stick 102 with the hot stick loop 195′ and push upwards. The upward movement of the suspended arrester 115′ will release the rounded end of arrester support member 1820 from its seated position within the ground connector 1815. Therefore, the damaged arrester 115′ and disconnector 120′ may be easily removed from arrester assembly 1800 without the technician having to remove any of the mounting hardware included in the arrester assembly 1800.

Accordingly, the present disclosure provides a replaceable surge arrester assembly that includes a disconnector device configured to prevent current arcing during failure of the arrester. In some embodiments, the disconnector and/or other components of the surge arrester assembly prevent sparks, and other flammable materials, from falling to the ground and on other electrical equipment after the disconnector device is operated.

Although aspects have been described in detail with reference to certain preferred embodiments, variations and modifications exist within the scope of one or more independent aspects as described.

What is claimed is:

1. An arrester assembly comprising:
a first support member;
a constant tension spring including a first end and a second end, the first end mechanically coupled to the first support member and the second end of the constant tension spring extends in a downward direction;
a disconnector assembly electrically connected to the second end of the constant tension spring;
a ground connector electrically connected to electrical ground; and
an arrester electrically connected between the disconnector assembly and electrical ground.

2. The arrester assembly of claim 1, further comprising a hot stick loop configured to engage a hot stick, the hot stick loop connected to one of the disconnector assembly and the arrester.

3. The arrester assembly of claim 1, wherein the first support member is a conductive rod that is electrically connected to a line conductor.

4. The arrester assembly of claim 3, wherein the conductive rod is clamped by a configurable mount that is supported by an electrical device proximate the arrester assembly.

5. The arrester assembly of claim 1, wherein the first end of the constant tension spring is mounted to the first support member by a mounting device that includes an aperture configured to receive the first support member.

6. The arrester assembly of claim 1, further including a ground connector with a ground clamp and a ground bracket that is connected to the ground clamp by a snap fit connection.

7. The arrester assembly of claim 6, wherein the ground bracket includes a conductive spring that is electrically connected to the arrester.

8. The arrester assembly of claim 6, wherein the ground bracket includes an aperture formed within and configured to engage a hot stick.

9. The arrester assembly of claim 1, wherein the second end of the constant tension spring is configured to retract vertically upwards upon operation of the disconnector assembly.

10. The arrester assembly of claim 1, wherein the disconnector assembly is connected to the second end of the constant tension spring by a spring clip that includes a protruding member that is configured to engage a hot stick.

11. The arrester assembly of claim 1, wherein the disconnector assembly includes: an insulator coupled to a first terminal and to a second terminal; and
a sleeve positioned around the insulator and moveable between an unextended position prior to the insulator breaking and an extended position after the insulator breaks, the sleeve being configured to trap debris produced by breaking the insulator.

12. The arrester assembly of claim 11, wherein the sleeve is a fire-resistant sleeve.

13. The arrester assembly of claim 11, wherein the disconnector assembly further includes a housing containing the insulator and the sleeve in the unextended position, the housing configured to break after the insulator breaks.

14. The arrester assembly of claim 13, wherein one of the housing and the sleeve further includes an arc-quenching material.

15. The arrester assembly of claim 13, wherein the insulator is coupled between a first insulator connector and a second insulator connector, and the sleeve is coupled to the first insulator connector and to the second insulator connector,
wherein the first terminal is coupled to the first insulator connector and the second terminal coupled to the second insulator connector, and
wherein an electrical connection between the first terminal and the second terminal is broken after the insulator breaks.

16. The arrester assembly of claim 11, wherein when a temperature threshold, an overvoltage threshold, leakage current, or an overcurrent threshold is met, the insulator breaks and the sleeve moves from the unextended position to the extended position.

17. An arrester assembly comprising:
a cutout bracket including a first connector and a second connector;
a disconnector assembly electrically connected to the first connector;
an arrester electrically connected to the second connector; and
a hot stick loop connected to one of the disconnector assembly and the arrester, the hot stick loop including an aperture that is configured to engage a hot stick.

18. The arrester assembly of claim 17, further comprising a support bracket that is electrically connected between the arrester and the second connector;
wherein the support bracket includes a rounded end that is electrically connected to the second connector.

19. The arrester assembly of claim 18, wherein the second connector includes a circular cutout that is configured to receive the rounded end of the support bracket.

20. The arrester assembly of claim 17, wherein the disconnector assembly includes:
an insulator coupled to a first terminal and to a second terminal; and
a sleeve positioned around the insulator and moveable between an unextended position prior to the insulator breaking and an extended position after the insulator breaks, the sleeve being configured to trap debris produced by breaking the insulator.
